(19) United States
(12) Patent Application Publication
(10) Pub. No.: US 2026/0192821 A1
(43) Pub. Date: Jul. 9, 2026

(54) END TO END AND HEURISTIC TRAJECTORY PLANNING FUSION FOR AUTOMATED DRIVING

(71) Applicant: GM Global Technology Operations LLC, Detroit, MI (US)

(72) Inventors: Rouhollah Sayed Jafari, Dearborn, MI (US); Alireza Esna Ashari Esfahani, San Bruno, CA (US); Brent Navin Roger Bacchus, Sterling Heights, MI (US)

(21) Appl. No.: 19/011,016

(22) Filed: Jan. 6, 2025

(51) Int. Cl. B60W 60/00; B60W 50/00; G05B 13/02

(52) U.S. Cl. CPC B60W 60/001; B60W 50/00; G05B 13/027; B60W 2050/0022

(57) ABSTRACT

A vehicle includes a sensor suite including at least one camera. A controller on the vehicle includes a processor and a memory. The memory stores an end to end trajectory planning module, a heuristic planning modification module, and a heuristic planner module. The end to end trajectory planning module is configured to receive a set of sensor signals from the sensor suite, generate a scene, and generate an end to end trajectory for the vehicle. The heuristic planning modification module is configured to receive the end to end trajectory and modify a weighting algorithm of the heuristic planner module based on the end to end trajectory. The heuristic planner module is configured to generate a set of heuristic actions, determine a reward value of each heuristic action using the weighting algorithm, and select a final heuristic action for the vehicle based on the determined reward values.

The subject disclosure relates to vehicles, and in particular to a system for fusing a vehicle's trajectory from an end to end network with a heuristic planner to generate a single vehicle trajectory.

Vehicles including autonomous driving systems and driver assistance systems use end to end systems, such as neural networks, to receive data from a surrounding environment and identify a scene in which the vehicle is operating. Based on the scene, a vehicle trajectory is determined and the trajectory is provided to the autonomous driving systems and/or the driver assistance systems and the vehicle is moved along the trajectory.

End to end systems, such as neural networks, do not include ways to identify constraints on determined trajectories (e.g. collision with other obstacles, single direction of travel on a one way road, speed limits, and the like). Similarly, the end to end systems lack explainability as to why a specific trajectory is output from the provided inputs.

Heuristic trajectory planning tracks constraints and is reverse engineerable. However, heuristic trajectory planning systems are defined by limited pre-established rules and cannot flexibly consider all possible scenarios. In addition, the output options of a heuristic trajectory planning system are substantially limited by the processing power of the vehicle.

Accordingly, it is desirable to provide a trajectory planning system for a vehicle that incorporates the flexibility of an end to end trajectory determination system with the explainability and constraint limitations of a heuristic trajectory planning system while still determining a single desired trajectory to implement.

### SUMMARY

In one exemplary embodiment a vehicle includes a sensor suite including at least one camera. A controller on the vehicle includes a processor and a memory. The memory stores an end to end trajectory planning module, a heuristic planning modification module, and a heuristic planner module. The end to end trajectory planning module is configured to receive a set of sensor signals from the sensor suite, generate a scene, and generate an end to end trajectory for the vehicle. The heuristic planning modification module is configured to receive the end to end trajectory and modify a weighting algorithm of the heuristic planner module based on the end to end trajectory. The heuristic planner module is configured to generate a set of heuristic actions, determine a reward value of each heuristic action using the weighting algorithm, and select a final heuristic action for the vehicle based on the determined reward values.

In addition to one or more of the features described herein the vehicle further includes at least one autonomous vehicle system configured to receive the final heuristic action and implement the final heuristic action.

In addition to one or more of the features described herein the heuristic planning modification module includes a constraint check configured to compare the end to end trajectory to at least one constraint and respond to the end to end trajectory violating the constraint by discarding the end to end trajectory.

In addition to one or more of the features described herein the heuristic planning modification module includes a trajectory to action conversion process, wherein the trajectory to action conversion process receives the end to end trajectory and outputs an action defining the end to end trajectory, and wherein the action is in a same format as the set of heuristic actions of the heuristic planner module.

In addition to one or more of the features described herein the heuristic planning modification module includes instructions configured to determine a set of deviations, with each deviation corresponding to a distance between the end to end action and one heuristic action in the set of heuristic actions.

In addition to one or more of the features described herein modifying the weighting algorithm of the heuristic planner module based on the end to end trajectory includes adding a deviation reward value to the reward weighting algorithm wherein the deviation reward value for an action is a function of the deviation of the that action from the end to end action.

In addition to one or more of the features described herein a resulting weighting algorithm is r(s,a_i)=r_base+w_la(r(d_i)), with r_base being a reward value of an unmodified weighting algorithm, w_la being a weighting constant and r(d_i) being a magnitude of the deviation of the action in the set of actions from the end to end action.

In addition to one or more of the features described herein the heuristic planner module recieves the scene from the end to end trajectory planning module and generates the set of heuristic actions for the vehicle based on the scene.

In addition to one or more of the features described herein the end to end trajectory planning module comprises a trained neural network configured to receive the set of sensor signals as the input and provide the end to end trajectory for the vehicle as an output.

In another exemplary embodiment a method for generating a set of vehicle actions includes receiving a set of sensor signals from a vehicle sensor suite at an end to end trajectory planning module being, generating a scene based on the sensor signals using the end to end trajectory planning module, and generating an end to end trajectory for the vehicle based on the scene using the end to end trajectory planning module. The method provides the end to end trajectory for the vehicle to a heuristic planning modification module and modifying a weighting algorithm of a heuristic planner module based on the end to end trajectory. The method generates a set of heuristic actions for the vehicle using the heuristic planner module, determining a reward value of each action in the set of actions using the weighting algorithm, and selecting a final action for the vehicle based on the determined reward values.

In addition to one or more of the features described herein the method further includes providing the final action to at least one autonomous vehicle system and implementing the final action using the at least one autonomous vehicle system.

In addition to one or more of the features described herein the heuristic planning modification module compares the end to end trajectory to at least one constraint and responds to the end to end trajectory violating the constraint by discarding the end to end trajectory using a constraint check.

In addition to one or more of the features described herein the heuristic planning modification module receives the end to end trajectory and generates an action defining the end to end trajectory using a trajectory to action conversion process, and wherein the action is in a same format as the actions of the heuristic planner actions.

In addition to one or more of the features described herein the heuristic planning modification module determines a set of deviations, with each deviation corresponding to a deviation between the end to end action and one heuristic action in the set of heuristic actions.

In addition to one or more of the features described herein modifying the weighting algorithm of the heuristic planner module based on the end to end trajectory includes adding a deviation reward value to the weighting algorithm wherein the deviation reward value for an action in the set of actions is a function of the deviation of the action in the set of actions from the end to end action.

In addition to one or more of the features described herein a resulting weighting algorithm is r(s,a_i)=r_base+w_la(r(d_i)), with r_base being a reward value of an unmodified weighting algorithm, w_la being a weighting constant and r(d_i) being a magnitude of the deviation of the action in the set of actions from the end to end action.

In addition to one or more of the features described herein the method further includes the heuristic planner module receives the scene from the end to end trajectory planning module and generating the set of heuristic actions for the vehicle based on the scene using the heuristic planner module.

In addition to one or more of the features described herein the end to end trajectory planning module comprises a trained neural network configured to receive the set of sensor signals as the input and provide the end to end trajectory for the vehicle as an output.

In yet another exemplary embodiment a vehicle controller includes a processor and a memory storing an end to end trajectory planning module, a heuristic planning modification module, and a heuristic planner module. The end to end trajectory planning module is configured to receive a set of sensor signals from the sensor suite, generate a scene using the set of received sensor signals, and generate an end to end trajectory for a vehicle. The heuristic planning modification module being configured to receive the end to end trajectory for the vehicle and adjust the end to end trajectory and modify a weighting algorithm of the heuristic planner module based on the end to end trajectory. The heuristic planner module is configured to generate a set of heuristic actions for the vehicle, determine a reward value of each heuristic action in the set of heuristic actions using the weighting algorithm, and select a final heuristic action for the vehicle based on the determined reward values.

In addition to one or more of the features described herein the controller is configured to implement the final heuristic action using an autonomous vehicle system.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a vehicle including a trajectory planning system;

FIG. 2 is an architecture for fusing a trajectory determined using an end to end network and trajectories determined using a heuristic planner;

FIG. 3 illustrates an example suggested end to end trajectory for a passing maneuver;

FIG. 4. illustrates an operation of the trajectory to action conversion process; and

FIG. 5 is an example process for operating the architecture of FIG. 2.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

As used herein, a controller refers to a control system including one or more processors and a memory configured to implement a function. The control system may be a dedicated controller including a single dedicated controller and a single processor, a remote processing system, multiple distributed processors configured to operate in conjunction, or any similar configuration arranged to implement the function.

In one general implementation of the systems and processes described herein, an end to end network is utilized to construct a trajectory along which a vehicle is traveling, as well as a scene through which the vehicle is traveling. The scene defines relative positions of real world objects and markings within the vicinity of the vehicle in a manner that is understandable for vehicle computer systems. The end to end network starts from sensor inputs and includes all intermediate modules, such as perception, prediction and planning, for outputting a final trajectory. The trajectory is output from the end to end planning system and used to modify a heuristic planning system. The modified heuristic planning system generates multiple possible heuristic trajectories using a set of heuristic rules. The process modifies a weighting algorithm based on the end to end trajectory and determines a best heuristic trajectory using the modified weighting algorithms. The best heuristic trajectory is provided to one or more autonomous vehicle systems and/or driver assistance systems.

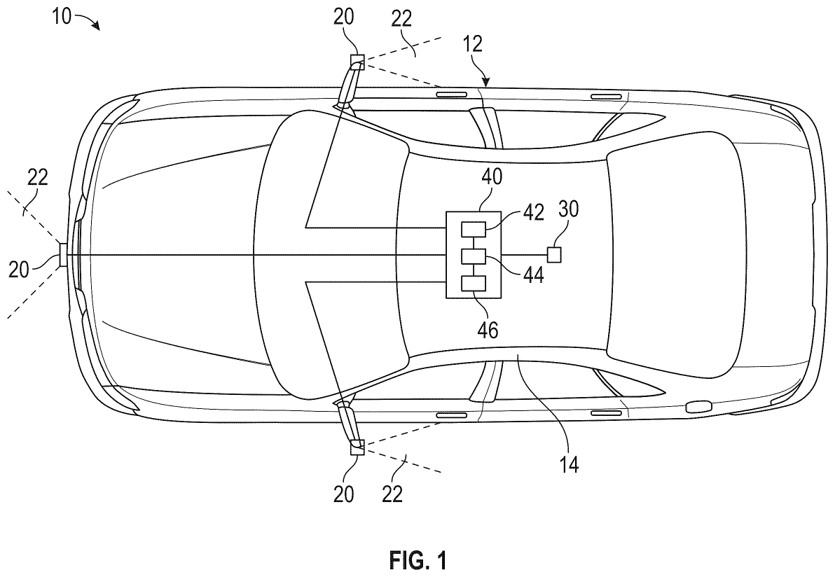

In accordance with an exemplary embodiment of the systems described herein, FIG. 1 illustrates a vehicle 10 including a body 12. The vehicle 10 includes a sensor suite having one or more cameras 20, each defining a field of view 22. The sensor suite further includes a light detection and ranging (lidar) sensor 30. The sensors 20, 30 in the sensor suite monitor a surrounding environment and provide the sensor readings to a controller 40. In the illustrated example of vehicle 10, the controller 40 is a dedicated trajectory planning controller 40. In alternative examples, the controller 40 may be a general controller including one or more trajectory planning modules or a set controllers distributed throughout the vehicle 10 and configured to operate in conjunction to achieve the trajectory planning described herein.

The controller 40 includes an end to end trajectory planning module 42, a heuristic planning modification module 44, and a heuristic planner module 46. In one example the end to end trajectory planning module 42 is a deep neural network configured to receive sensor information indicative of a surrounding environment from the cameras 20 and the lidar sensor 30 and generate a trajectory for the vehicle 10 to travel. As an intermediate stage of generating the trajectory, the end to end network 42 generates a scene describing relative positions of elements in the surrounding environment (e.g., trees, lanes, lane markers, road edges, other vehicles, signs, etc.) as well as providing context for some elements within the scene. By way of example, the end to end network may identify a stop sign and a stop line at an intersection and contextually identify that the stop sign indicates the vehicle 10 must stop, and the stop line indicates where the vehicle 10 must stop.

The end to end trajectory planning module 42 generates a trajectory for the vehicle to travel along based on the scene. As the end to end trajectory planning module 42 is trained on a large data set using machine learning processes, the generated trajectory is more flexible to a varied scene, but may not strictly apply all required constraints.

The trajectory generated by the end to end trajectory planning module 42 is provided to the heuristic planning modification module 44. Based on the trajectory provided, and the scene, the heuristic planning modification module 44 adjusts the rules and weights that are used to select the best heuristically planned trajectory within the heuristic planner module 46.

In addition, the scene generated at the intermediate stage is provided to the heuristic planner module 44. The heuristic planner module 44 applies predetermined heuristic rules to the scene and generates a set of corresponding trajectories. The generated trajectories are provided to the one or more autonomous vehicle systems and/or driver assistance systems. The best trajectory is then implemented according to any conventional system.

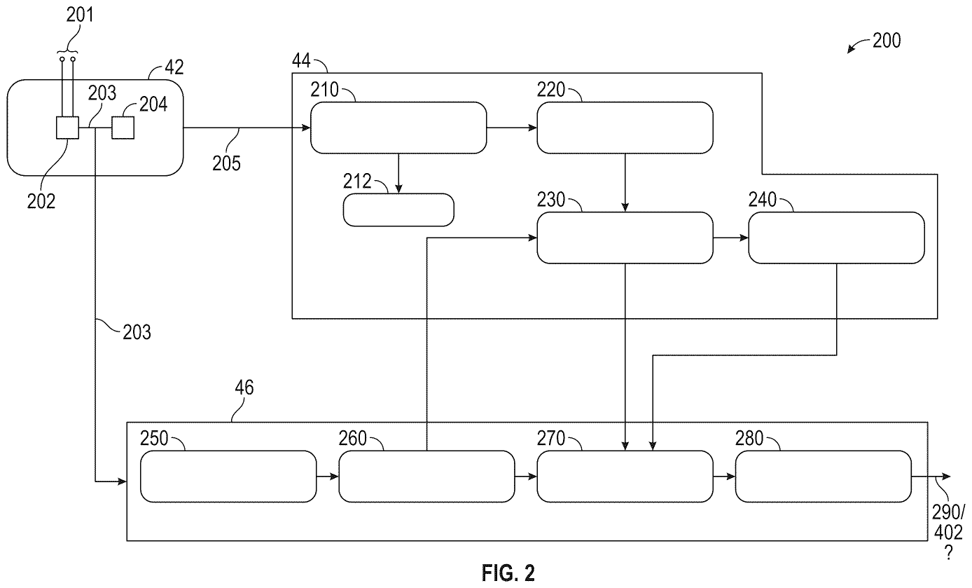

With continued reference to FIG. 1, FIG. 2 illustrates an architecture 200 of the end to end trajectory planning module 42, the heuristic planning modification module 44, and the heuristic trajectory planner module 46 according to one implementation.

In the architecture 200 of FIG. 2, the end to end network 42 is a neural network module configured to receive inputs 201 of sensor data including images from the cameras 20, the lidar sensor 30, and any other sensors that may be included in a vehicle 10 sensor suite. An intermediate step 202 within the end to end network 42 generates a scene 203 of the environment through which the vehicle 10 is traveling. The scene is provided to a subsequent step 204 within the end to end network 42, and the subsequent step 204 generates a suggested end to end trajectory 205 for the vehicle 10 to travel along based on the scene. The suggested end to end trajectory can be generated according to any known or conventional end to end trajectory 205 generation technique and is passed to the heuristic planning modification module 44.

In addition to being passed to the subsequent step 204, the scene 203 is passed to the heuristic trajectory planner module 46. The heuristic trajectory planner 46 heuristically determines a set of potential trajectories that can be utilized. The potential trajectories are considered using a reward algorithm, and the highest scoring trajectory is determined to be the best trajectory. The best trajectory is then implemented by the vehicle 10. The heuristic trajectory planner module 46 includes a path planner 250 that receives the scene elements and generates paths, an action generator 260 configured to generate sets of actions that can implement each generated path, an action selector 270 configured to apply the reward algorithm to the sets of actions and identify the best action, and a trajectory generator 280 configured to convert the selected best action into a trajectory which is a list of waypoints including spatial and temporal profiles of the future motion to be followed by the vehicle. Each of the path planner 250, action generator 260, action selector 270, and trajectory generator 280 can operate according to any conventional heuristic trajectory planning process.

In the example of FIG. 2, the heuristic planning modification module 44 is configured to adjust the actions and modify the weights applied within the reward algorithm using a trajectory 205 generated by the end to end network, thereby achieving benefits of both the end to end network 42 and the heuristic trajectory planner module 46.

Within the heuristic planner modification module 44, the suggested end to end trajectory 205 is initially compared to a set of constraints in a constraints check 210. The constraints check 210 applies any hard constraints to the suggested end to end trajectory. As used herein hard constraints are rules that any given trajectory may not violate. In one example the constraints are predefined heuristically (e.g., the vehicle 10 may not collide with any other obstacles, a top speed of the vehicle 10 may not exceed 85 mph, the vehicle 10 may never pass multiple vehicles at once, the vehicle 10 may not cross double road lines, the vehicle 10 may not intersect with other objects in the scene). In another example, at least a portion of the constraints are generated based on information presented in the scene (e.g. a speed limit sign setting a top speed, a stop sign requiring the vehicle 10 to stop). In a typical example, the hard constraints will be a combination of predefined heuristic constraints and scene based constraints including collision restraints, out of road boundary constraints, speed limit constraints, kinematic constraints (maximum and minimum acceleration, deceleration and jerk), and rules of the road constraints (stop bar, dedicated turn lanes, yield, traffic lights, etc.).

With continued reference to FIGS. 1 and 2, FIG. 3 illustrates one example suggested end to end trajectory 205 for a passing maneuver in which the vehicle 10 is attempting to pass a leading vehicle 304 while a third vehicle 306 is traveling in a lane 308 adjacent to the lane 310 in which the vehicle 10 is traveling. Implementation of the suggested end to end trajectory 205 will result in the vehicle 10 moving through a position 10′ where the vehicle 10 would intersect (collide) with the third vehicle 306. This suggested end to end trajectory 302 violates the constraint against a collision and fails the constraint check 210.

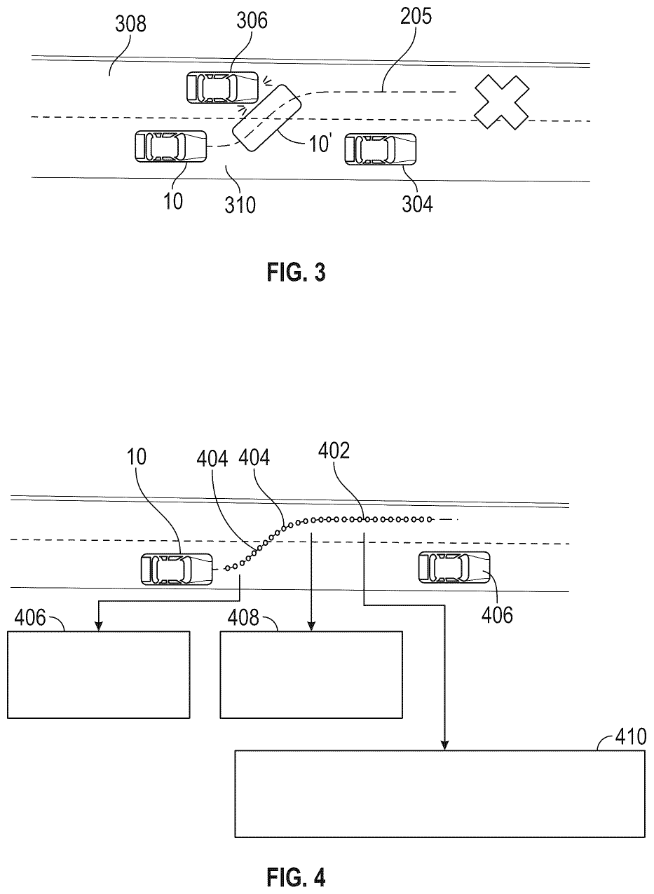

Referring again to FIG. 2, when the constraints check fails (as in the example of FIG. 3), the heuristic planner modification module 44 discards the suggested end to end trajectory and shifts to utilizing the heuristic trajectory planner module 46 unmodified to determine a final trajectory to be implemented by autonomous and/or semi-autonomous vehicle systems in an end step 212.

When the constraints check passes (e.g., no hard constraints are violated) the heuristic planner modification module 44 provides the suggested end to end trajectory to a trajectory to action conversion process 220. Within the trajectory to action conversion, the process 220 converts the format of the end to end trajectory from an output format of the end to end network to a format utilized by the heuristic trajectory planning module 46. With continued reference to FIGS. 1 and 2, FIG. 4 illustrates one exemplary operation of the trajectory to action conversion process 220.

In the example of FIG. 4, a suggested end to end trajectory 402 is output as a sequence of points 404 that the vehicle 10 should pass through to achieve a vehicle passing maneuver allowing the vehicle 10 to pass a leading vehicle 406 ahead of the vehicle 10. In contrast to this format, the heuristic trajectory planner module 46 utilizes a trajectory format defined by one or more actions. In the example of FIG. 4, the suggested end to end trajectory 402 can be described as an action. Depending on the particularities of the system being utilized the form of the action may be varied. By way of non-limited example, FIG. 4 defines a set of three possible actions 406, 408, 410 that may be implemented. The first action 406 defines a kinematic action by a unit of acceleration and a magnitude of lateral offset that the vehicle 10 should achieve. The second action 408 defines a goal of the maneuver with a target lane and a target velocity at the conclusion of the maneuver. The third action 410 defines the progression of the maneuver along the suggested end to end trajectory 402 as a first polynomial function s(t) with the station (s, position) relative to the starting position of the vehicle 10 at a time t, and a second polynomial function with the lateral offset (d) of the vehicle 10 at a time t

$$s ( t ) = a\_n * t \hat{} n + a\_ ( n - 1 ) * t \hat{} ( n - 1 ) + … + a\_ 1 * t + a\_ 0$$

$$d ( t ) = b\_m * t \hat{} m + b\_ ( m - 1 ) * t \hat{} ( m - 1 ) + … + b\_ 1 * t + b\_ 0$$

where a and b are computed based on the practical system being implemented.

The three actions 406, 608, 410 defining the maneuver to achieve the suggested end to end trajectory 402 provided in the example of FIG. 4 are exemplary in nature and a heuristic trajectory planner module 46 may use any similar action based formatting.

Referring again to FIG. 2, by converting the suggested end to end trajectory 402 to the action which has the same format of the heuristic planner (e.g., any of the actions 406, 408, 410) the suggested end to end trajectory 402 can be compared to, and utilized alongside, the sets of actions generated using the action generator 260 of the heuristic trajectory planner module 46. Once the format of the end to end trajectory 205 has been converted, the converted trajectory is provided to an actions modification process 230 within the heuristic planning modifier module 44.

The actions modification process 230 also receives the sets of actions from the action generator 260 and compares the actions defining the end to end trajectory from the trajectory planning module 42 in the new format to the sets of actions from the action generator 260. The comparison determines a mathematical distance between the action defining the end to end trajectory with the sets of actions defining the heuristically determined trajectories. When the converted action of the end to end module 42 is above a predetermined threshold distance from the set of actions of the heuristic planner, the converted action of the end to end trajectory planning module 42 is added to the action sets and provided to the action selector 270.

The mathematical distance between actions depends on the action format of the heuristic planner and can be determined using any conventional formula.

Once the distance between the end to end action and each of the heuristically determined actions has been determined, the distances are provided to a reward modification process 240 in the heuristic planning modification module 44. The reward modification process 240 adds a weighting component to the reward function used by the action selector 270.

In one example, the modified reward function can take the form of:

$$r ( s , a\_i ) = r\_base + w\_la ( r ( d\_i ) )$$

With r_base being a base (unmodified) reward of the heuristic trajectory planner module 46, and w_la(r(d_i)) being the additional weighting coefficient, and the additional weighting component being dependent on (e.g., a function of) the distance of each action from the converted end to end action. In some examples r_base may be depending on a desired speed/acceleration profile, jerk accumulation, consistency over time, proximity to center of lane, and/or any other desirable trajectory characteristics. By making the modified weighting component a function of the distance to the end to end action, the closer the heuristically determined action is to the action determined using the end to end network 42, the larger the weight of the weighting component and therefore, a better chance of that action to be executed. The specific reward coefficient can be tuned to meet the needs of the system. After applying the modified weights, the best action is selected and passed to the trajectory generator 280, where the selected action is converted to a trajectory 290 sent to the controller to be executed.

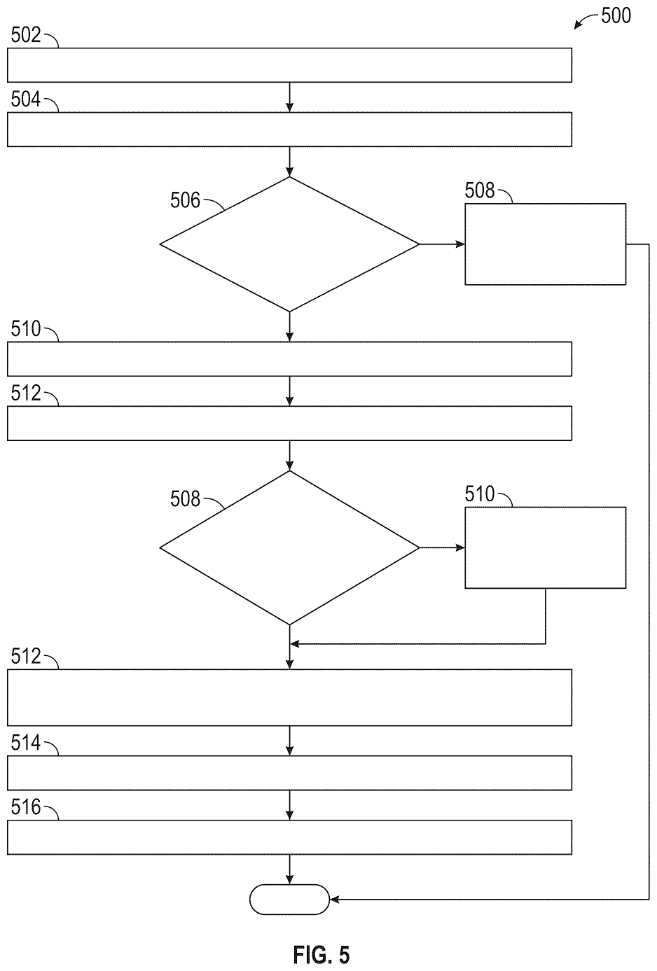

With continued reference to the architecture 200 of FIG. 2, and generally to all of FIGS. 1-4, FIG. 5 illustrates a process for operating the architecture 200 to fuse the end to end network trajectory with the heuristically determined planner. Initially the process 500 receives the trajectory generated by the end to end network in a get learned trajectory step 502. The trajectory is compared to the constraints in a compare to constraints step 504 and a check 506 is operated to determine if all constraints are passed. When the end to end trajectory violates one or more constraints, the process 500 discards the end to end trajectory, and continues with only the heuristically determined trajectories according to conventional heuristic trajectory determination processes in a continue with heuristic planner step 508.

When none of the constraints are violated, the end to end trajectory is converted to the format of the heuristically determined actions in a conversion step 510, and the distance between the converted end to end action and each of the heuristic actions is determined in a distance step 512. Once the distances are determined, the process 500 checks if the action determined using the end to end network is more than a threshold distance away from all of the heuristically determined actions in a check 508. When the action determined by the end to end network is farther away than the threshold distance, the end to end action is added to the actions to be evaluated by the heuristic trajectory planner module 46 in an add action step 510, after adding the action 510, or when the check 508 indicates that the distance is less than the threshold, the process 500 modifies the weighting algorithm within the heuristic planner in a modification step 512.

Once the weighting algorithms have been modified, the reward values for all the actions are determined in a reward step 514, and the action with the highest reward value is applied in an apply action step 516. The apply action step 516 includes providing action to a trajectory generation module, generating the trajectory with the trajectory generation module, and providing the generated trajectory to the controller which can then implement the trajectory.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A vehicle comprising:
a sensor suite including at least one camera;
a controller including a processor and a memory, the memory storing an end to end trajectory planning module, a heuristic planning modification module, and a heuristic planner module;
the end to end trajectory planning module being configured to receive a set of sensor signals from the sensor suite, generate a scene using the sensor signals, and generate an end to end trajectory for the vehicle;
the heuristic planning modification module being configured to receive the end to end trajectory for the vehicle and modify a weighting algorithm of the heuristic planner module based on the end to end trajectory;
the heuristic planner module being configured to generate a set of heuristic actions for the vehicle, determine a reward value of each heuristic action in the set of heuristic actions using the weighting algorithm, and select a final heuristic action for the vehicle based on the determined reward values.

2. The vehicle of claim 1, further comprising at least one autonomous vehicle system configured to receive the final heuristic action and implement the final heuristic action.

3. The vehicle of claim 1, wherein the heuristic planning modification module includes a constraint check configured to compare the end to end trajectory to at least one constraint and respond to the end to end trajectory violating the constraint by discarding the end to end trajectory.

4. The vehicle of claim 1, wherein the heuristic planning modification module includes a trajectory to action conversion process, wherein the trajectory to action conversion process receives the end to end trajectory and outputs an action defining the end to end trajectory, and wherein the action is in a same format as the set of heuristic actions of the heuristic planner module.

5. The vehicle of claim 4, wherein the heuristic planning modification module includes instructions configured to determine a set of deviations, with each deviation corresponding to a distance between the end to end trajectory and one heuristic action in the set of heuristic actions.

6. The vehicle of claim 5, wherein modifying the weighting algorithm of the heuristic planner module based on the end to end trajectory includes adding a deviation reward value to the reward weighting algorithm wherein the deviation reward value for an action is a function of the deviation of that action from the end to end action.

7. The vehicle of claim 6, wherein a resulting weighting algorithm is r(s,a_i )=r_base +w_la(r(d_i)), with r_base being a reward value of an unmodified weighting algorithm, w_la being a weighting constant and r(d_i) being a magnitude of the deviation of the action in the set of actions from the end to end action.

8. The vehicle of claim 1, wherein the heuristic planner module recieves the scene from the end to end trajectory planning module and generates the set of heuristic actions for the vehicle based on the scene.

9. The vehicle of claim 1, wherein the end to end trajectory planning module comprises a trained neural network configured to receive the set of sensor signals as an input and provide the end to end trajectory for the vehicle as an output.

10. A method for generating a set of vehicle actions comprising:
receiving a set of sensor signals from a vehicle sensor suite at an end to end trajectory planning module being, generating a scene based on the sensor signals using the end to end trajectory planning module, and generating an end to end trajectory for a vehicle based on the scene using the end to end trajectory planning module;
providing the end to end trajectory for the vehicle to a heuristic planning modification module and modifying a weighting algorithm of a heuristic planner module based on the end to end trajectory;
generating a set of heuristic actions for the vehicle using the heuristic planner module, determining a reward value of each action in the set of actions using the weighting algorithm, and selecting a final action for the vehicle based on the determined reward values.

11. The method of claim 10, further comprising providing the final action to at least one autonomous vehicle system and implementing the final action using the at least one autonomous vehicle system.

12. The method of claim 10, wherein the heuristic planning modification module compares the end to end trajectory to at least one constraint and responds to the end to end trajectory violating the constraint by discarding the end to end trajectory using a constraint check.

13. The method of claim 10, wherein the heuristic planning modification module receives the end to end trajectory and generates an action defining the end to end trajectory using a trajectory to action conversion process, and wherein the action is in a same format as the actions of the set of heuristic planner actions.

14. The method of claim 13, wherein the heuristic planning modification module determines a set of deviations, with each deviation corresponding to a deviation between the end to end action and one heuristic action in the set of heuristic actions.

15. The method of claim 14, wherein modifying the weighting algorithm of the heuristic planner module based on the end to end trajectory includes adding a deviation reward value to the weighting algorithm wherein the deviation reward value for an action in the set of actions is a function of the deviation of the action in the set of actions from the end to end action.

16. The method of claim 15, wherein a resulting weighting algorithm is r(s,a_i )=r_base+w_la(r(d_i)), with r_base being a reward value of an unmodified weighting algorithm, w_la being a weighting constant and r(d_i) being a magnitude of the deviation of the action in the set of actions from the end to end action.

17. The method of claim 10, further comprising the heuristic planner module receives the scene from the end to end trajectory planning module and generating the set of heuristic actions for the vehicle based on the scene using the heuristic planner module.

18. The method of claim 10, wherein the end to end trajectory planning module comprises a trained neural network configured to receive the set of sensor signals as an input and provide the end to end trajectory for the vehicle as an output.

19. A vehicle controller comprising a processor and a memory storing an end to end trajectory planning module, a heuristic planning modification module, and a heuristic planner module;
the end to end trajectory planning module being configured to receive a set of sensor signals from a sensor suite of a vehicle, generate a scene using the set of received sensor signals, and generate an end to end trajectory for the vehicle;
the heuristic planning modification module being configured to receive the end to end trajectory for the vehicle and adjust the end to end trajectory and modify a weighting algorithm of the heuristic planner module based on the end to end trajectory;
the heuristic planner module being configured to generate a set of heuristic actions for the vehicle, determine a reward value of each heuristic action in the set of heuristic actions using the weighting algorithm, and select a final heuristic action for the vehicle based on the determined reward values.

20. The vehicle controller of claim 19, wherein the controller is configured to implement the final heuristic action using an autonomous vehicle system.
